(19) United States
(12) Patent Application Publication
(10) Pub. No.: US 2004/0244195 A1
(43) Pub. Date: Dec. 9, 2004

(54) Method for making a blade ring

(76) Inventors: Gerard Michel Roland Gueldry, Evry (FR); Jacky Naudet, Bondoufle (FR)

Correspondence Address: Oblon Spivak McCelland Maier & Neustadt, Fourth Floor, 1755 Jefferson Davis Highway, Arlington, VA, 22202, US

(21) Appl. No.: 10/492,542

(22) PCT Filed: Dec. 6, 2002
(86) PCT No.: PCT/FR02/04201

(30) Foreign Application Priority Data
Dec. 6, 2001 (FR) 01.15757

(51) Int. Cl. B23P 15/04

(52) U.S. Cl. 29/889.21

(57) ABSTRACT

A method for making a blade ring includes producing an outer shell of a blade ring by setting a blank using a plasma-forming process on a frame that is then removed. The tips of the blades are well embedded in the ferrule independently of their profile, such that the aerodynamic performances do not deteriorate.

The present invention relates to a method for manufacturing a blade ring, of the type comprising two concentric shells and intermediate blades connecting them.

At present, there are two main methods for joining the blades to the shells. In the first, the ring is produced as a foundry part and undergoes the necessary machining to remove extra thicknesses and to adjust the shape of the blades. The ring quality is very good, but manufacture is difficult since it is not easy to avoid deformations during machining; there are restrictions on the choice of the shape of the blades, which furthermore must be made of the same material as the shells; finally, there are connecting radii between the blades and the shells that lower aerodynamic performance.

In the other main method, blades and shells are manufactured separately, and then assembled together and brazed; but brazing has only moderate resistance and remains difficult to carry out for the highly bent blades that are increasingly appreciated because of their good performance; finally, the precision of the assembly must be verified and the play between the blades and the shells carefully adjusted.

Another complex method used in this technical field can be mentioned, comprising a brazing and a sintering, and described in the U.S. Pat. No. 5,732,468.

The invention relates to a different method in which, to summarize, at least one of the shells is formed by plasma spraying and then machined to the definitive shape.

This arrangement is of interest because the restrictions and disadvantages mentioned above are essentially present at the tips of the blades, whereas they are much less evident at their feet. Thus it is easy to make a preliminary assembly of the ring by placing blade tenons in the notches of a shell with blade feet manufactured separately (and to be brazed at the foot of the blades in a manner known to those skilled in the art, when assembly is complete). A frame is then placed on the tips of the blades, capping them; this acts to keep them in place and to receive the plasma deposited on it to form a shell blank. Finally, machining shapes the shell to give it the required profile; the frame can be removed by machining or other methods, or can remain in place as a portion of the shell.

The shell formed by plasma projection fits at the tips of the blades without difficulty and produces a solid assembly.

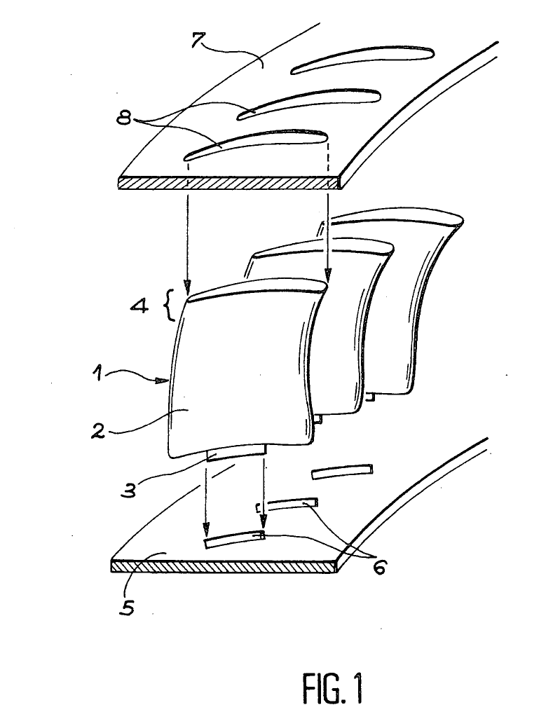

A detailed description of a preferred embodiment of the invention will now be described with reference to FIGS. 1, 2, 3, 4 and 5.

In FIG. 1, each blade 1 comprises, apart from a main vane part 2, a tenon 3 at its foot; one can also see a collar 4 which will no longer be part when the ring has been constructed. The collar 4 is opposite to the foot 3.

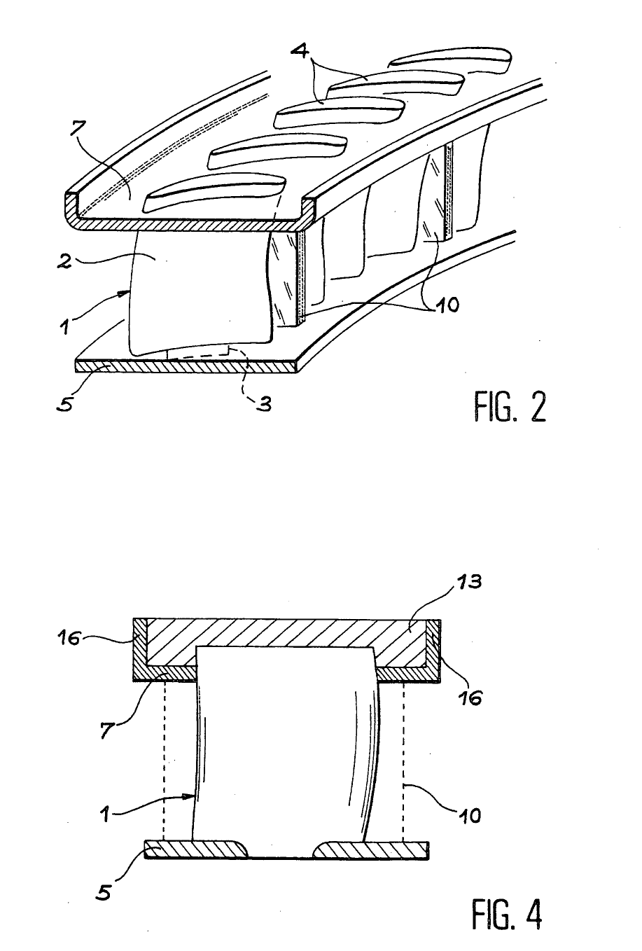

The blades 1 are brought towards an inner shell 5 equipped with notches 6. The first stage of the method consists of introducing the tenons 3 into the notches 6, then a frame 7 composed of contiguous ring segments and also provided with notches 8 is brought in and assembled with the blades 1 in such a way as to cap them by making the collars 4 fit into the notches 8. The assembly as a whole is shown in FIG. 2. Spacers 10 are introduced between the blades 1 to maintain the separation between the inner shell 5 and the frame segments 7.

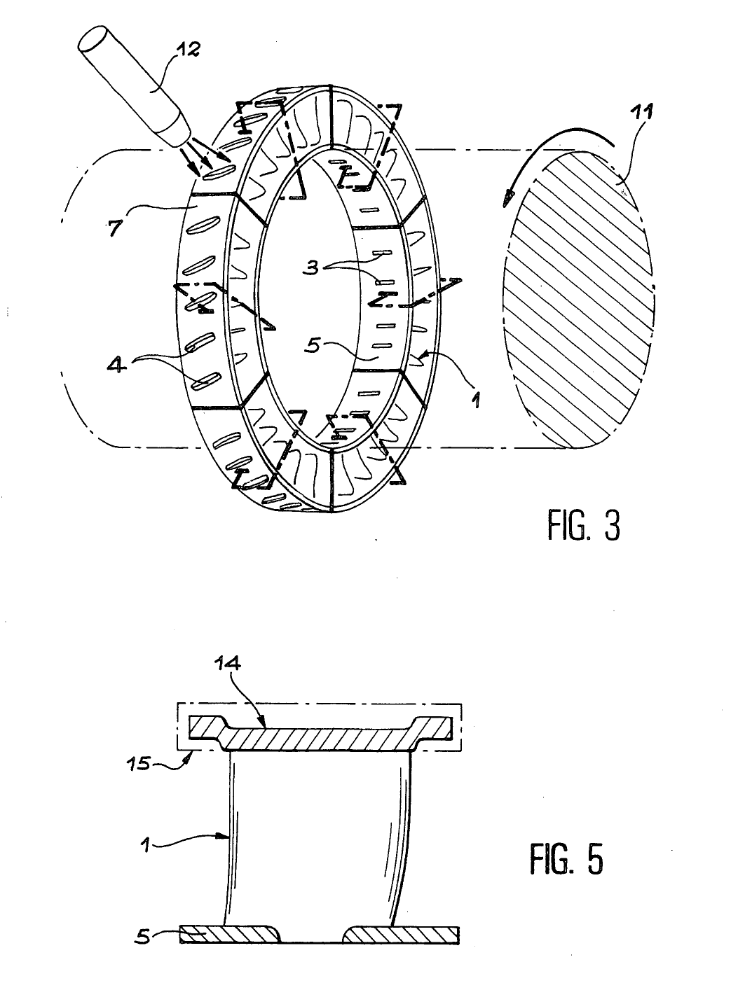

In FIG. 3, the assembly, mounted on a support tooling 11 of a type comprising, in particular, a turning hub and locking fingers, is moved in front of a metallizing torch 12 that projects metallic powder in the form of plasma onto the frame 7, coating the collars 4. After several turns of the tooling 12, a layer of adequate thickness will have been deposited, forming a blank 13 as in FIG. 4. The frame 7 can then be removed by machining or by another method, together with the spacers 10. Optionally one can choose a structure or a material with low resistance for the frame 7 in order to simplify this condition.

Next, FIG. 5 shows that the blank 13 can be machined to provide an outer shell 14 with the required cross section, the removed portion having reference number 15. The machining is carried out on the flanks and on the outside of the blank 13, but not normally inside to avoid touching the blades 1, and in particular their connections to the outer shell 14 with its complex shape. The result is that the vanes 2 are well embedded in the outer shell 14. The mechanical and aerodynamic requirements for the feet of the blades are not as demanding, and brazing the tenons 3 in the notches 6 results in a satisfactory ring assembly.

The machining can be made easier if the frame 7 is concave and limited by a pair of flanks 16 to contain the blank 13; metallization is then stopped when the concavity is full. Thus a more even blank of the outer shell 14 is obtained.

1-3. (Canceled).

4. A manufacturing method for a blade ring composed of two concentric shells and intermediate blades connecting the shells, comprising:
fitting tenons of the blades into one of the shells;
embedding tips of the blades opposite the tenons into an annular frame;
depositing a blank of the other shell by plasma on the frame; and
machining the blank to form the other shell, the frame having been removed.

5. A method according to claim 4, wherein the frame has an annular concavity for receiving the blade blank.

6. A method according to claim 4, wherein spacers are placed between the blades, on the shell in which the tenons are embedded and under the frame.

7. A method according to claim 5, wherein spacers are placed between the blades, on the shell in which the tenons are embedded and under the frame.
